(19) United States
(12) Patent Application Publication
(10) Pub. No.: US 2011/0274223 A1
(43) Pub. Date: Nov. 10, 2011

(54) AGC TUNER FOR MIMO SYSTEMS

(75) Inventors: Pradeep Agarwal, Alwar (IN); Prashant Aggarwal, Delhi (IN); Somya Sharma, New Delhi (IN)

(73) Assignee: VIRTUALWIRE TECHNOLOGIES PRIVATE LIMITED, New Delhi (IN)

(21) Appl. No.: 12/822,169

(22) Filed: Jun. 23, 2010

(30) Foreign Application Priority Data
May 5, 2010 (IN) 1057/DEL/2010

(51) Int. Cl. H04L 27/08

(52) U.S. Cl. 375/345

(57) ABSTRACT

The present disclosure provides methods and systems for automatic gain control (AGC) in a multiple input multiple output (MIMO) system having two or more receiver chains, each receiver chain including a receiver and an AGC module. The AGC system accepts a signal at a compensation module associated with the receiver chain and calculates one or more gains using the AGC module associated with the receiver chain. Then, an estimation module computes a scaling factor for each receive chain from the gains and transmits the scaling factor to the compensation module of the respective receiver chain, which requantizes the signal based on the scaling factor.

### FIELD

This application relates generally to communication systems, and more particularly, to methods and systems for implementing high-performance automatic gain control (AGC).

### BACKGROUND

MIMO (multiple-input, multiple-output) is a technique for increasing transmission capacity of a communication system by employing multiple antennas at transmitters or receivers.

Generally, in MIMO systems, each transmitter/receiver antenna has its own independent RF chain including for example, receiving antennas, LNA (low noise amplifiers), down converters, filters, VGA (variable gain amplifiers), and ADC (analog to digital converters). The ADC output is processed in baseband modules to recover transmitted signals.

All the RF chains are coupled to the baseband modules, where the independent RF chains are combined to minimize bit error rate (BER). The baseband modules implement digital signal-processing algorithms for signal reception and recovery, such as time and frequency synchronization, channel estimation, phase noise and jitter tracking, bit decoding, controlling inputs to RF modules and so on.

The gain provided by the VGA is set by an AGC (Automatic Gain Controller), which is designed to utilize the full dynamic range of the ADC and minimize the quantization noise at the output of the ADC. To utilize the full dynamic range of the ADC, varying amplitudes received at a receiver chain need to be re-tuned. Thus, the VGA amplifies certain low-amplitude signals and attenuates certain high-amplitude signals. The AGC module implements a method, referred to as an AGC method that defines a set of rules for calculating the gains.

In a MIMO receiver, signals reaching different antennas are subjected to different fading and interference conditions. Moreover, the RF noise figure and interference noise from other communicating systems or receiver chains may not be the same. Thus, the signal to noise ratio (SNR) at different receiver chains may differ significantly.

Most typical digital signal-processing algorithms are based on combining signals from different receive chains. An algorithm performs at highest performance levels when the weight of each signal involved in the combining operation is proportional to its SNR. Conversely, if a low SNR signal is has a high weight in the combining operation, the system experiences performance loss. This phenomenon is generally referred to as noise enhancement in the art.

Designing an AGC method, which sets the VGA gain in accordance with the SNR received, adds minimum quantization noise to the received signal, and does not suffer from noise enhancement is challenging for MIMO systems.

At present, two types of AGC methods exist—equal or joint AGC methods and independent AGC methods. The former technique sets equal gain for all RF chains in a MIMO system, resulting in addition of high quantization noise in the system. The latter technique determines the gain for a RF chain based on the received signal strength at the RF chain. This technique results in low quantization noise in the system, however, the gain is not determined based on the SNR, leading to enhancement of noise along with the signal. Moreover, neither technique accounts for varying noise figure and interference conditions at different receiver chains.

Accordingly, there exists a need for an independent AGC method that prevents system performance degradation due to noise enhancement while taking into account RF noise figures at different RF chains and interference noise from other communicating systems.

### SUMMARY

The present disclosure provides a method for automatic gain control (AGC) in a multiple input multiple output (MIMO) system having two or more receiver chains, each receiver chain including a receiver and an AGC module. The method includes accepting a signal at a compensation module associated with the receiver chains. Further, the method calculates one or more gains using the AGC module associated with the receiver chains and utilizes an estimation module to compute a scaling factor from the gains. Then, the method transmits the scaling factor to the compensation module, which requantizes the signal based on the scaling factor.

The disclosure also provides an AGC tuner for a MIMO system. The AGC tuner includes two or more receiver chains. Each receiver chain includes a receiver front-end circuit for receiving a signal, a variable gain amplifier, connected to the receiver front-end circuit, and an analog to digital converter to convert the output signal from the variable gain amplifier to digital form. Additionally, each receiver chain includes an AGC circuit, connected to the variable gain amplifier, for calculating one or more gains and a compensation module, connected to the analog to digital converter, for requantizing an output signal from the analog to digital converter. The AGC tuner further includes an estimation module that receives the gains from the AGC circuits, generates a scaling factor for a receiver chain based on the gains, and provides the scaling factor to the compensation module in the receiver chain.

### BRIEF DESCRIPTION OF THE DRAWINGS

The figures described below and attached hereto set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary embodiment of an independent AGC receiver system for multiple input multiple output (MIMO) systems.

FIG. 2 shows an exemplary embodiment of an AGC tuner method implemented in a MIMO system.

FIG. 3 is an exemplary state diagram depicting flow of an independent AGC method.

FIG. 4 depicts an exemplary functional block diagram for generating a scaling factor in an estimation module.

FIG. 5 shows an exemplary functional block diagram for generating a requantized signal in a compensation module.

FIG. 6 illustrates an exemplary functional block diagram for generating a scaling factor and quantization information in an estimation module.

FIG. 7 shows an exemplary functional block diagram for generating a requantized signal in a compensation module.

FIG. 8 depicts an exemplary bit decoder for decoding a requantized signal received from a compensation module.

FIG. 9 illustrates an alternate exemplary bit decoder for decoding a requantized signal received from a compensation module using quantization information.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes methods and systems for implementing independent automatic gain control (AGC) that prevents system performance degradation due to noise enhancement while taking into account different RF noise figures at different RF chains and interference noise from other communicating systems. The embodiments of the disclosure add a compensation module to each receiver chain and further, add an estimation module to a multiple input multiple output (MIMO) system. The method steps disclosed in the embodiments include determining gains for independent RF chains using an AGC module in each RF chain; determining scaling factors for different RF chains; and requantizing analog to digital converter (ADC) output based on the scaling factors. Some embodiments further disclose the steps of calculating quantization information for each RF chain and using the quantization information in baseband modules for reducing complexity.

### Exemplary Embodiments

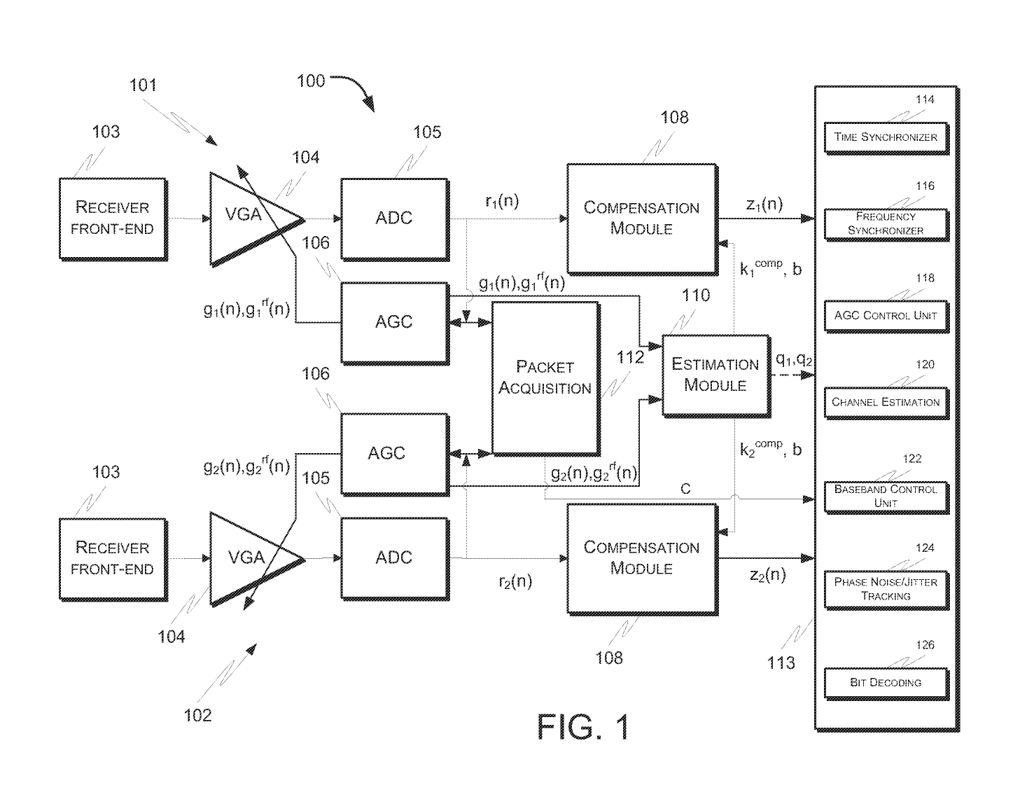

FIG. 1 illustrates an exemplary embodiment of an independent AGC receiver system 100 for MIMO systems. The receiver system 100 may include several receiver chains, of which two are shown in FIG. 1—a first receiver chain 101 and a second receiver chain 102. Each receiver chain includes a receiver front-end 103 a variable gain amplifier (VGA) 104, an ADC 105, an AGC module 106, and a compensation module 108. The receiver system 100 further includes an estimation module 110 and may include a packet acquisition module 112. After processing received signals with an AGC method, the processed signals are transmitted to baseband modules 113, such as a time synchronizer 114, a frequency synchronizer 116, an AGC control unit 118 (which interacts with the other baseband modules 113 to control the timing of the AGC related operations), a channel estimation module 120, a baseband control unit 122, a phase noise/jitter tracking module 124, and a bit decoding module 126.

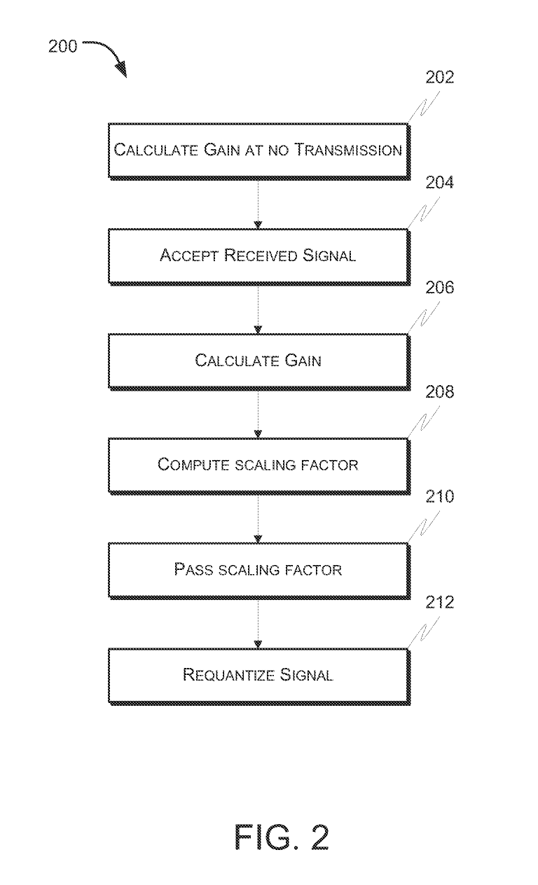

A receiver chain, such as the first receiver chain 101, receives a signal at the receiver front-end 103, which may be equipped with an antenna. The receiver front-end 103 provides the received signal to the VGA 104, which in turn, applies a gain, provided by the AGC module 106, to the received signal. The AGC module 106 sets one or more gains. In one implementation, the gains may include a noise gain [symbol] and a gain determined for a received signal [symbol] . In a further implementation, the noise gain [symbol] takes into account noise figure and interference at the receiver chain. FIG. 1 shows the AGC module 106 providing gains [symbol] and [symbol] for the first receiver chain 101 and [symbol] and [symbol] for the second receiver chain 102 to the VGAs 104 of the respective receiver chains. The estimation module 110 and the compensation module 108 manage noise enhancement resulting from amplification of a signal, as will be explained in relation with FIGS. 2 to 7.

The VGA 104 then transmits the signal to the ADC 105 that converts the signal to digital form. The ADC 105 output ( [symbol] for the first receiver chain 101 and for the second receiver chain 102) is also provided to the AGC module 106 and the packet acquisition module 112.

The estimation module 110 receives gains, including an AGC gain for the received signal and an AGC gain for noise, from the AGC modules 106 of all receiver chains (in FIG. 1, [symbol] and [symbol] for the first receiver chain 101 and [symbol] and [symbol] for the second receiver chain 102) and computes a scaling factor for each receiver chain based on the gains calculated at different receiver chains. In FIG. 1, the estimation module 110 computes the scaling factor [symbol] for the first receiver chain 101 and [symbol] for the second receiver chain 102. Further, in certain embodiments, the estimation module 110 computes quantization information, which is provided to the baseband modules 113 (shown as a dotted arrow) for reducing complexity, as will be discussed in relation with FIG. 9. Quantization information for the first receiver chain 101 and the second receiver chain 102 is represented as q₁ and q₂ respectively, in FIG. 1.

The compensation module 108 receives the ADC 105 output and the scaling factor from the estimation module 110, employing them for generating a requantized signal (described later in relation with FIGS. 5 and 7). The requantized signal is then provided to the baseband modules 113 for further processing. FIG. 1 shows that [symbol] and [symbol] are the requantized signals for the first receiver chain 101 and the second receiver chain 102, respectively. Further, the packet acquisition module 112 provides control information C to the baseband control unit 122, which may indicate whether a data packet has been received.

It should be noted that the embodiments disclosed may be implemented as part of an existing AGC system or as an independent module. The disclosed embodiments prevent performance degradation due to noise enhancement and take into account different RF noise figures and interference noise from other communicating systems at different RF chains. Further, the disclosed embodiments for MIMO systems are applicable to any nature of modulation and transmission scheme, such as orthogonal frequency division multiplexing (OFDM), code division multiple access (CDMA) and so on. Further, the disclosed embodiments may be applied in wire line as well as wireless systems.

FIG. 2 shows an exemplary embodiment of an AGC tuner method 200 implemented in the receiver system 100. The method 200 considers an N×M MIMO system where N(>=1) is the number of transmitter chains and M(>=2) is the number of receiver chains.

The steps of the method 200 are described in regard with one receiver chain in the receiver system 100, although the method 200 steps may be implemented at each receiver chain in the receiver system 100. When the receiver system 100 is turned on, the AGC module 106 sets the gain of each receiver chain, at step 202, when no transmission is being performed from a transmitter or when sᵢ(n)=0 for all n (sᵢ(n) represents the transmitted signal from i^{th} antenna, where 1<=i<=N). The gain at no transmission [symbol] at a receiver chain j may be represented in the form of equation 1:

[symbol] (1)

[symbol] is a reference power at the ADC 105 output, which may be the same for all the ADCs 105, K is number of samples in a unit time, n₀ is a reference sample, [symbol] is Gaussian noise, [symbol] is RF noise, and [symbol] is the interference noise. Alternatively, [symbol] may be set to a constant value, if a user does not want to estimate the gain for noise or at no transmission. In one implementation, the constant value is zero. Thus, the gain at no transmission is determined and stored for each receiver chain, and the receiver system 100 then begins seeking an incoming transmission.

The steps discussed here onward may be carried out for each received data packet, considering the fact that received signal amplitude fluctuates significantly based on environmental conditions. Alternatively, the steps of the method 200 may be performed at predetermined intervals. The receiver system 100 accepts a received signal at step 204. At this point, the AGC module 106 is enabled and depending on the AGC method implemented, the AGC module 106 calculates a gain value at step 206. In one embodiment, the gain value is determined from a look-up table stored in the receiver system 100. The look-up table may have noise gain entries corresponding to different values of VGA gains, determined through experimentation, observation, or simulation.

In a N×M MIMO system, if sᵢ is the transmitted signal from antenna i and i=1,2, . . . N, the signal received by a receiving antenna j and appearing at the VGA 104 output may be represented in the form of the following equation 2:

[symbol] (2)

[symbol] is channel impulse response from the transmitting antenna i to the receiving antenna j, and [symbol] is the gain applied by the AGC module 106 of receive chain j at time instant n. [symbol] represents convolution operation.

[symbol] may be calculated based on equation 3:

[symbol] (3)

In addition to calculating the gains for the VGA 104, the AGC module 106 feeds the gains to the estimation module 110 for calculating the scaling factor, at step 208. At step 210, the estimation module 110 passes the scaling factor to the compensation module 108, which requantizes the ADC 105 output based on the scaling factor, at step 212. In one embodiment, a parameter called quantization information, required by the baseband modules 113, may also be calculated by the estimation module 110. The requantized signal is used by the baseband modules 113 for further processing.

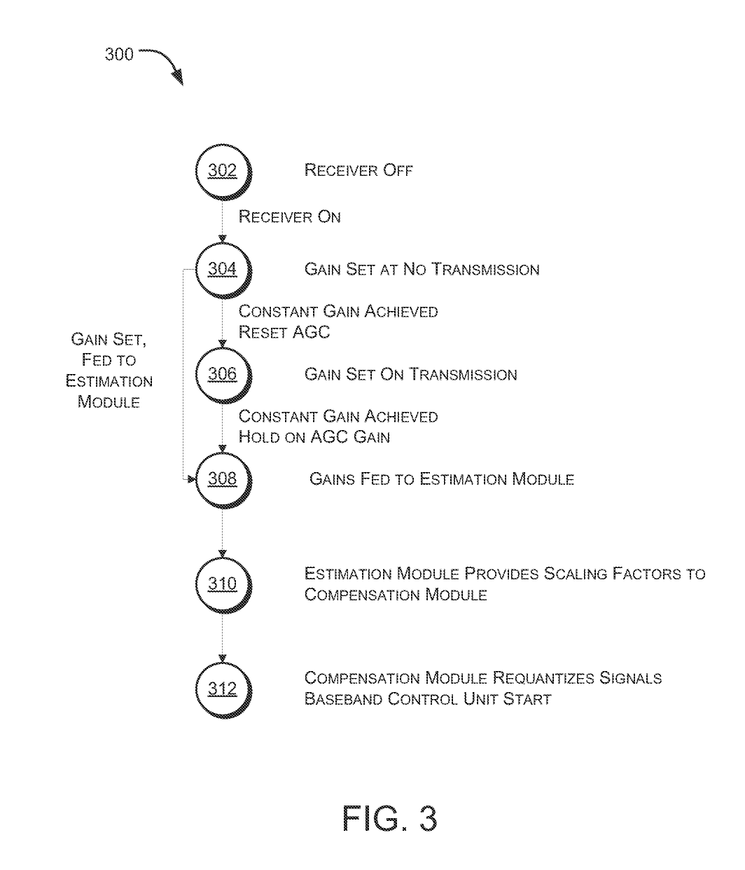

FIG. 3 is an exemplary state diagram 300 depicting flow of an independent AGC method executed in conjunction with the receiver system 100. At state 302, the receiver system 100 is off. Once the receiver system 100 is turned on, the AGC module 106 gain is set when there is no incoming transmission, at state 304. Constant AGC module 106 gain is then achieved and the receiver system 100 is reset. At 306, the AGC module 106 gain is set for a received transmission. Once constant gain is achieved, the AGC module 106 holds the AGC gain. At state 308, both gains, set during transmission and at no transmission, are fed to the estimation module 110, which calculates scaling factors based on the gains. At state 310, the estimation module 110 provides the scaling factors to the compensation module 108, which requantizes the received signal based on the scaling factors, at state 312. Further, the baseband control unit 122 starts, which controls the operation of the baseband modules 113.

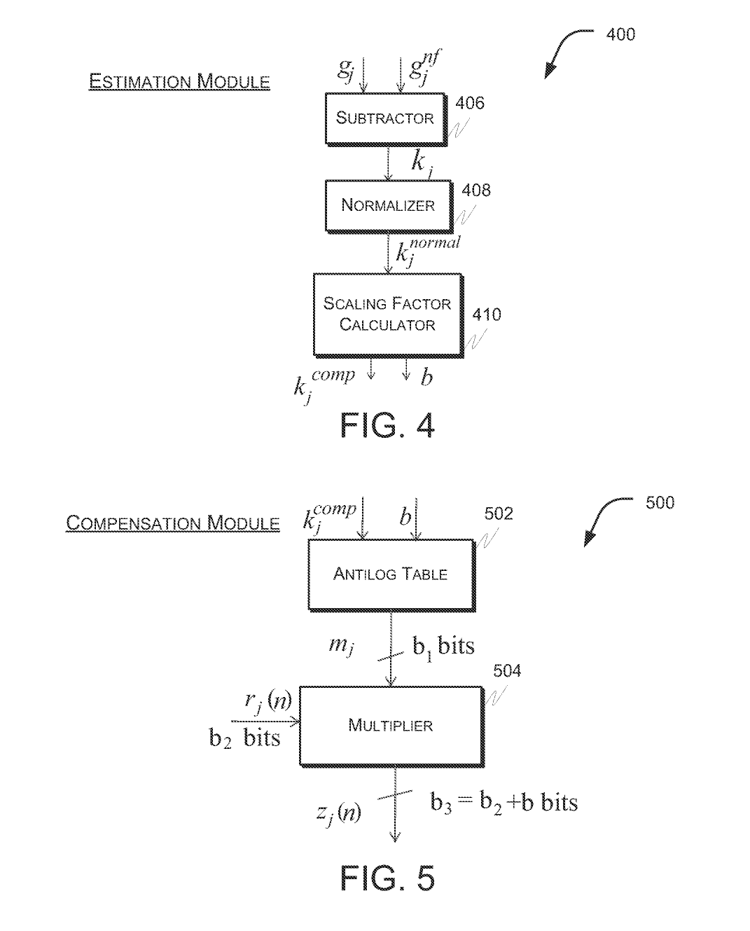

FIG. 4 depicts an exemplary functional block diagram 400 for generating a scaling factor in the estimation module 110, which computes the scaling factors based on the gains received from the AGC module 106.

The gain [symbol] set during reception of a transmission, and the gain [symbol] set at no transmission, serve as inputs to a subtractor 406, which calculates a gain [symbol] , according to equation 4:

[symbol] =(4)

[symbol] may be normalized such that the maximum value of [symbol] in all receiver chains is 0, preventing signal clipping at the compensation module 108 output. A normalizer 408 may generate a normalized value of [symbol] based on equation 5, although other methods of performing normalization are conceivable:

[symbol] (5)

A scaling factor calculator 410 may calculate the scaling factor [symbol] based on equation 6:

[symbol] (6)

Here, we refer to the range of spread of [symbol] as [symbol] , a system parameter that may have a predetermined value. [symbol] can be used to determine bitwidth b required for [symbol] based on equation 7, ceil representing the mathematical ceiling function well known in the art:

[symbol] (7)

The estimation module 110 provides the scaling factor [symbol] and bitwidth b to the compensation module 108.

FIG. 5 shows an exemplary functional block diagram 500 for generating a requantized signal in the compensation module 108.

Here, the compensation module 108 includes an antilog table 502 and a multiplier 504. The antilog table 502 may compute the antilog [symbol] of [symbol] (received from the scaling factor calculator 410), represented in b₁ bits, based on equation 8, round representing the mathematical rounding function well known in the art:

[symbol] (8)

The compensation module 108, which receives the ADC 105 output [symbol] , the bitwidth b, and the scaling factor [symbol] (from the scaling factor calculator 410), generates a requantized signal output [symbol] , used by the baseband modules 113 for further processing. The multiplier 504 may compute [symbol] based on equation 9:

[symbol] (9)

Table 1 shows an example of the implementation of the functionality of the functional block diagrams 400 and 500, for a 4×4 MIMO system. Here, [symbol] is 24 dB and b₁ is 10 bits. An 8-bit ADC is used in all the receiver chains.

TABLE 1

| Receive chain index | 1 | 2 | 3 | 4 | Unit |
|---|---|---|---|---|---|
| | 10 | 17 | 9 | 22 | dB |
| | 25 | 27 | 26 | 26 | dB |
| | 15 | 10 | 17 | 4 | dB |
| | −2 | −7 | 0 | −13 | dB |
| b₁ | 10 | 10 | 10 | 10 | — |
| bitwidth (b₂) | 8 | 8 | 8 | 8 | — |
| b | 4 | 4 | 4 | 4 | — |
| | −2 | −7 | 0 | −13 | dB |
| bitwidth | 12 | 12 | 12 | 12 | — |
| (b₃ = b₁ + b₂ − (b₁ − b)) = b₂ + b | | | | | |

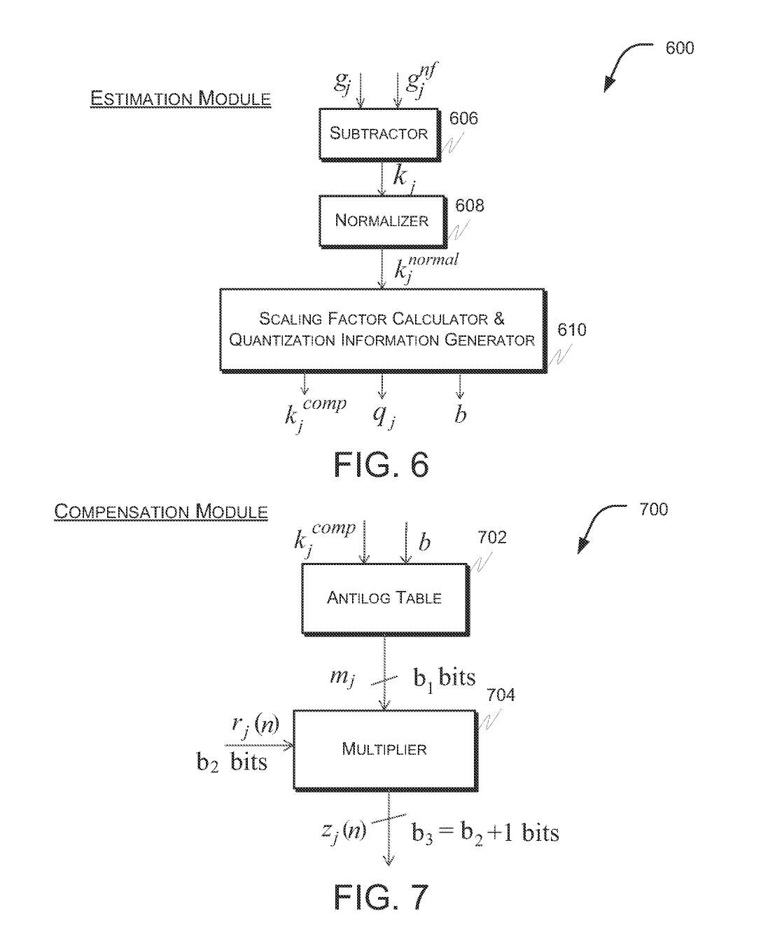

FIG. 6 illustrates an exemplary functional block diagram 600 for generating a scaling factor in the estimation module 110. Further, the functional block diagram 600 generates quantization information, used by the baseband modules 113 to reduce the hardware complexity.

As described in relation with FIG. 4, in the functional block diagram 600, the gain [symbol] and the gain [symbol] serve as inputs to a subtractor 606, which calculates a gain [symbol] , according to the equation 4. [symbol] is further normalized to prevent signal clipping at the compensation module 108 output. A normalizer 608 may generate a normalized value of [symbol] based on the equation 5.

A scaling factor calculator and quantization information generator 610 may compute quantization information [symbol] based on equation 10, floor representing the mathematical floor function well known in the art:

[symbol] (10)

Further, the scaling factor calculator and quantization information generator 610 may calculate the scaling factor [symbol] based on equation 11:

[symbol] (11)

The estimation module 110 may also calculate the bitwidth b based on the equation 7. The scaling factor [symbol] and the bitwidth b are provided to the compensation module 108.

FIG. 7 shows an exemplary functional block diagram 700 for generating a requantized signal in the compensation module 108. Here, the compensation module 108 includes an antilog table 702 and a multiplier 704.

As described in relation with FIG. 5, the antilog table 702 may compute the antilog [symbol] of [symbol] (received from the scaling factor calculator and quantization information generator 610), represented in b₁ bits, based on the equation 8.

The compensation module 108, which receives the ADC 105 output [symbol] and the scaling factor [symbol] (from the scaling factor calculator and quantization information generator 610), generates a requantized signal output [symbol] , used by the baseband modules 113 for further processing. The multiplier 504 may compute [symbol] based on equation 12, floor representing the mathematical floor function well known in the art:

[symbol] (12)

Table 2 shows an example of the functionality of the functional block diagram 600 and the functional block diagram 700, for a 4×4 MIMO system. Here, [symbol] is 24 dB and b₁ is 10 bits. An 8-bit ADC is used in all the receiver chains.

TABLE 2

| Receive chain index | 1 | 2 | 3 | 4 | Unit |
|---|---|---|---|---|---|
| | 10 | 17 | 9 | 22 | dB |
| | 25 | 27 | 26 | 26 | dB |
| | 15 | 10 | 17 | 4 | dB |
| | −2 | −7 | 0 | −13 | dB |
| b₁ | 10 | 10 | 10 | 10 | — |
| bitwidth (b₂) | 8 | 8 | 8 | 8 | — |
| b | 4 | 4 | 4 | 4 | — |
| | 0 | 1 | 0 | 2 | — |
| | −2 | −1 | 0 | −1 | dB |
| bitwidth | 9 | 9 | 9 | 9 | — |
| (b₃ = b₁ + b₂ − (b₁ − 1)) = b₂ + 1 | | | | | |

In both, the methods described in relation with FIGS. 4 and 5, and FIGS. 6 and 7, the ADC 105 bitwidth can be maintained constant, without compromising on the levels of quantization noise or noise enhancement that may be introduced by the AGC module 106.

The requantized signal generated by the functional block diagram 500 or the functional block diagram 700 is provided to the baseband modules 113 for further processing. Here, consider the example of the bit decoding module 126. Typical DSP algorithms implemented in bit-decoding block involve first, multiplying the signal [symbol] at different receiver chains with different coefficients [symbol] , and second, summing the multiplier outputs of the different receiver chains to generate an estimate of the transmitted signal [symbol] . Coefficients [symbol] are determined such that they minimize the bit error rate (BER).

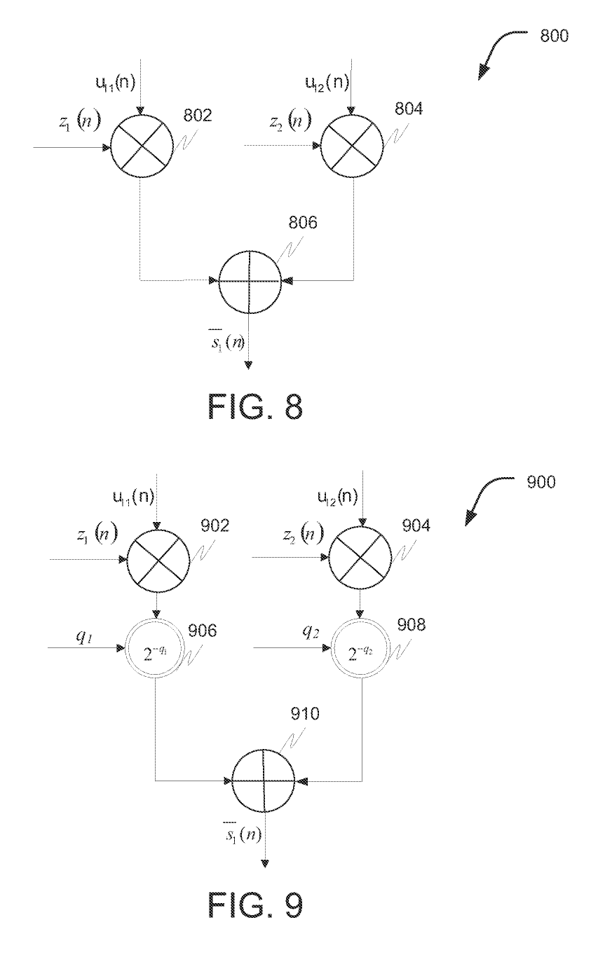

FIG. 8 depicts an exemplary bit decoder 800 for decoding a requantized signal received from the functional block diagram 500, for a 1×2 MIMO system. Here, a signal [symbol] from a first transmitter is received by two receiver chains—a first receiver chain and a second receiver chain.

Multiplier 802 accepts a coefficient [symbol] (for the first transmitter and the first receiver chain) and multiplies it with the requantized signal [symbol] for the first receiver chain. Similarly, multiplier 804 multiplies [symbol] (for the first transmitter and the second receiver chain) and multiplies it with the requantized signal [symbol] for the second receiver chain. An adder 806 sums the outputs of the multipliers 802 and 804 and produces an estimate of the transmitted signal [symbol] . A generalized form of equation 13 may be employed by the bit decoder 800 for estimating the transmitted signal as follows:

[symbol] (13)

FIG. 9 illustrates an alternate exemplary bit decoder 900 for decoding a requantized signal received from the functional block diagram 700 using the quantization information. Here, a signal [symbol] from a first transmitter is received by two receiver chains—a first receiver chain and a second receiver chain.

Multiplier 902 accepts a coefficient [symbol] (for the first transmitter and the first receiver chain) and multiplies it with the requantized signal [symbol] for the first receiver chain. Similarly, multiplier 904 multiplies [symbol] (for the first transmitter and the second receiver chain) and multiplies it with the requantized signal [symbol] for the second receiver chain. Block 906 receives [symbol] from the functional block diagram 700 and multiplies the output of the multiplier 902 with [symbol] . Similarly, block 908 receives [symbol] from the functional block diagram 700 and multiplies the output of the multiplier 904 with [symbol] . An adder 910 sums the outputs of the blocks 906 and 908 and produces an estimate of the transmitted signal [symbol] . A generalized form of equation 14 may be employed by the bit decoder 900 for estimating the transmitted signal as follows:

[symbol] (14)

Employing quantization information [symbol] lowers the bitwidth of the signals provided to the baseband modules 113, thus lowering complexity within the baseband modules 113. This can be seen from Table 2, where [symbol] bitwidth is 9 bits, much lower compared to 12 bits in Table 1, where [symbol] is not employed in the system.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the disclosure, which is determined solely by reference to the appended claims.

### CONCLUSION

The present disclosure provides systems and methods for implementing independent automatic gain control (AGC) while preventing system performance degradation due to noise enhancement and taking into account different RF noise figures at different RF chains and interference noise from other communicating systems.

The specification sets out a number of specific exemplary embodiments, but persons of skill in the art will understand that variations in these embodiments will naturally occur in the course of embodying the subject matter of the disclosure in specific implementations and environments. It will further be understood that such variations, and others as well, fall within the scope of the disclosure. Neither those possible variations nor the specific examples set above are set out to limit the scope of the disclosure. Rather, the scope of claimed disclosure is defined solely by the claims set out below.

What is claimed is:

1. A method for automatic gain control (AGC) in a multiple input multiple output (MIMO) system having two or more receiver chains, each receiver chain including a receiver and an AGC module, the method comprising:
accepting a signal at a compensation module associated with the receiver chain;
calculating one or more gains using the AGC module associated with the receiver chain;
computing a scaling factor from the gains by an estimation module;
transmitting the scaling factor to the compensation module; and
requantizing the signal based on the scaling factor by the compensation module.

2. The method of claim 1, wherein the gains include a gain applied to the receiver chain on receiving the signal, based on an equation:
$${g}_{j} = 10 * {log}_{10} ( \frac{{P}_{ref}}{{\sum }_{n = n 0}^{n = n 0 + K} \{ {[ Re ( {r}_{j} ( n ) ) ]}^{2} + {[ Im ( {r}_{j} ( n ) ) ]}^{2} \}} ) ,$$
wherein P_{ref} is a reference power, K is number of samples per unit time, n₀ is a reference sample, rⱼ(n) is the received signal, and gⱼ is the gain applied by the AGC module of a receiver chain j.

3. The method of claim 1, wherein the gains include a gain computed when no transmission is in progress within the MIMO system, based on an equation:
$${g}_{j}^{nf} = 10 * {log}_{10} ( \frac{{P}_{ref}}{{\sum }_{n = n 0}^{n = n 0 + K} \{ \begin{matrix}{[ Re ( {w}_{j} ( n ) + {w}_{j}^{rf} ( n ) + {w}_{j}^{interference} ( n ) ) ]}^{2} + \\ {[ Im ( {w}_{j} ( n ) + {w}_{j}^{rf} ( n ) + {w}_{j}^{interference} ( n ) ) ]}^{2}\end{matrix} \}} ) ,$$
wherein P_{ref} is a reference power, K is number of samples per unit time, n₀ is a reference sample, wⱼ(n) is Gaussian noise, wⱼ^{rf}(n) is RF noise, wⱼ^{interference}(n) is the interference noise, and gⱼ^{nf} is the AGC module gain for noise at receiver chain j.

4. The method of claim 1, wherein the gains include a noise gain gⱼ^{nf} being set to a constant value.

5. The method of claim 1, wherein the computing step includes calculating a difference gain based on an equation: kⱼ=gⱼ^{nf}−gⱼ, gⱼ being the gain applied by AGC module of a receiver chain j, gⱼ^{nf} being the AGC gain for noise, and kⱼ being the difference gain for the receiver chain j.

6. The method of claim 5, wherein the estimation module further computes a bitwidth b based on an equation:
$$b = ceil ( \frac{\vert {k}^{range} \vert}{6} ) ,$$
b being the bitwidth required for k^{range}, k^{range} being a system parameter indicating the range of spread of kⱼ^{normal}, wherein kⱼ^{normal} is a normalized value of kⱼ.

7. The method of claim 6, wherein the scaling factor is calculated based on an equation: kⱼ^{comp}=kⱼ^{normal}, kⱼ^{normal} being a normalized value of kⱼ and kⱼ^{comp} being the scaling factor.

8. The method of claim 7, wherein the requantized signal is calculated based on an equation: zⱼ(n)=floor(mⱼ*rⱼ(n)*2^{-(b}₁^{-b)}), zⱼ(n) being the requantized signal, mⱼ being an antilog table output, based on kⱼ^{comp} and b₁, generated by the compensation module, rⱼ(n) being the received signal at the receiver chain j, b₁ being the bitwidth of mⱼ, and b being the bitwidth required for k^{range}.

9. The method of claim 6, wherein the estimation module performs the steps of:
generating a quantization information signal by the estimation module, according to an equation:
$${q}_{j} = floor ( \frac{\vert {k}_{j}^{normal} \vert}{6} ) ,$$
qⱼ being the quantization information signal, and kⱼ^{normal} being a normalized value of kⱼ at the receiver chain j, wherein qⱼ is utilized for processing by baseband modules; and
providing the quantization information signal to baseband modules.

10. The method of claim 9, wherein the scaling factor is calculated based on an equation: kⱼ^{comp}=kⱼ^{normal}+6*qⱼ, kⱼ^{normal} being a normalized value of kⱼ, qⱼ being the quantization information signal, and kⱼ^{comp} being the scaling factor.

11. The method of claim 10, wherein the requantized signal is calculated based on an equation: zⱼ(n)=floor(mⱼ*rⱼ(n)*2^{-(b}₁⁻¹⁾), zⱼ(n) being the requantized signal, mⱼ being an antilog table output, based on kⱼ^{comp} and b₁, generated by the compensation module, rⱼ(n) being the received signal at the receiver chain j, and b₁ being the bitwidth of mⱼ.

12. The method of claim 1 further comprising providing the requantized signal to a baseband module by the compensation module.

13. An automatic gain control (AGC) tuner for a multiple input multiple output (MIMO) system, the AGC tuner comprising:
two or more receiver chains, each receiver chain including:
a receiver front-end circuit configured to receive a signal;
a variable gain amplifier operatively coupled with the receiver front-end circuit;
an analog to digital converter configured to convert the output signal from the variable gain amplifier to digital form;
an AGC module, operatively coupled to the variable gain amplifier, configured to calculate one or more gains; and
a compensation module, operatively coupled to the analog to digital converter, configured to requantize an output signal from the analog to digital converter; and
an estimation module configured to:
receive the gains from the AGC module;
generate a scaling factor for a receiver chain based on the gains; and
provide the scaling factor to the compensation module in the receiver chain.

14. The AGC tuner of claim 13, wherein the compensation module is configured to requantize the signal based on the scaling factor provided by the estimation module.

15. The AGC tuner of claim 13, wherein the gains include a gain applied to the receiver chain on receiving the signal, based on an equation:
$${g}_{j} = 10 * {log}_{10} ( \frac{{P}_{ref}}{{\sum }_{n = n 0}^{n = n 0 + K} \{ {[ Re ( {r}_{j} ( n ) ) ]}^{2} + {[ Im ( {r}_{j} ( n ) ) ]}^{2} \}} ) ,$$
P_{ref} being a reference power, K is number of samples per unit time, n₀ is a reference sample, rⱼ(n) being the received signal, and gⱼ being the gain applied by the AGC module of a receiver chain j.

16. The AGC tuner of claim 13, wherein the gains include a gain computed when no transmission is in progress within the MIMO system, based on an equation:
$${g}_{j}^{nf} = 10 * {log}_{10} ( \frac{{P}_{ref}}{{\sum }_{n = n 0}^{n = n 0 + K} \{ \begin{matrix}{[ Re ( {w}_{j} ( n ) + {w}_{j}^{rf} ( n ) + {w}_{j}^{interference} ( n ) ) ]}^{2} + \\ {[ Im ( {w}_{j} ( n ) + {w}_{j}^{rf} ( n ) + {w}_{j}^{interference} ( n ) ) ]}^{2}\end{matrix} \}} ) ,$$
P_{ref} being a reference power, K is number of samples per unit time, n₀ is a reference sample, wⱼ(n) being Gaussian noise, wⱼ^{rf}(n) being RF noise, wⱼ^{interference}(n) being the interference noise, and gⱼ^{nf} being the AGC module gain for noise at receiver chain j.

17. The AGC tuner of claim 13, wherein the gains include a noise gain gⱼ^{nf} being set to a constant value.

18. The AGC tuner of claim 13, wherein the estimation module is further configured to calculate a difference gain based on an equation: kⱼ=gⱼ^{nf}−gⱼ, gⱼ being the gain applied by AGC module of a receiver chain j, gⱼ^{nf} being the AGC gain for noise, and kⱼ being the difference gain for the receiver chain j.

19. The AGC tuner of claim 18, wherein the estimation module is further configured to compute a bitwidth b based on an equation:
$$b = ceil ( \frac{\vert {k}^{range} \vert}{6} ) ,$$
b being the bitwidth required for k^{range}, k^{range} being a system parameter indicating the range of spread of kⱼ^{normal}, wherein kⱼ^{normal} is a normalized value of kⱼ.

20. The AGC tuner of claim 19, wherein the estimation module generates the scaling factor based on an equation: kⱼ^{comp}=kⱼ^{normal}, kⱼ^{normal} being a normalized value of kⱼ and kⱼ^{comp} being the scaling factor.

21. The AGC tuner of claim 20, wherein the compensation module requantizes the output signal based on an equation: zⱼ(n)=floor(mⱼ*rⱼ(n)*2^{-(b}₁^{-b)}), zⱼ(n) being the requantized signal, mⱼ being an antilog table output, based on kⱼ^{comp} and b₁, generated by the compensation module, rⱼ(n) being the received signal at the receiver chain j, b₁ being the bitwidth of mⱼ, and b being the bitwidth required for k^{range}.

22. The AGC tuner of claim 19, wherein the estimation module is further configured to:
generate a quantization information signal, according to an equation:
$${q}_{j} = floor ( \frac{\vert {k}_{j}^{normal} \vert}{6} ) ,$$
qⱼ being the quantization information signal, and kⱼ^{normal} being a normalized value of kⱼ at the receiver chain j, wherein qⱼ is utilized for processing by baseband modules; and
configured to provide the quantization information signal to baseband modules.

23. The AGC tuner of claim 22, wherein the estimation module generates the scaling factor based on an equation: kⱼ^{comp}=kⱼ^{normal}+6*qⱼ, kⱼ^{normal} being a normalized value of kⱼ, qⱼ being the quantization information signal, and kⱼ^{comp} being the scaling factor

24. The AGC tuner of claim 23, wherein the compensation module requantizes the output signal based on an equation: zⱼ(n)=floor(mⱼ*rⱼ(n)*2^{-(b}₁⁻¹⁾), zⱼ(n) being the requantized signal, mⱼ being an antilog table output, based on kⱼ^{comp} and b₁, generated by the compensation module, rⱼ(n) being the received signal at the receiver chain j, and b₁ being the bitwidth of mⱼ.

25. The AGC tuner of claim 13, wherein the compensation module is further configured to provide the requantized signal to a baseband module.
